(19) United States
(12) Patent Application Publication
(10) Pub. No.: US 2016/0264112 A1
(43) Pub. Date: Sep. 15, 2016

(54) Three Stage Distributor Valve

(71) Applicant: WABTEC HOLDING CORP., Wilmerding, PA (US)

(72) Inventors: Stojce Smileski, Skopje (MK); Filip Hadzi-Nurev, Skopje (MK)

(73) Assignee: Wabtec Holding Corp., Wilmerding, PA (US)

(21) Appl. No.: 15/031,835

(22) PCT Filed: Oct. 28, 2014
(86) PCT No.: PCT/US2014/062566

§ 371 Date: Apr. 25, 2016

Related U.S. Application Data
(60) Provisional application No. 61/897,579, filed on Oct. 30, 2013.

(51) Int. Cl. B60T 8/18; B60T 13/68; B60T 13/66

(52) U.S. Cl. CPC B60T 8/1825; B60T 13/665; B60T 13/683

(57) ABSTRACT

A distributor valve system for a railway vehicle including a brake pipe, a relay valve, an auxiliary reservoir in line between the brake pipe and the relay valve to establish fluid communication between the brake pipe and the relay valve, and a brake cylinder in fluid communication with the relay valve. The relay valve has a plurality of positions corresponding to different amounts of pressurized air applied to the brake cylinder. The relay valve may include a plurality of chambers that are filled with pressurized air according to the amount of air pressure needed for the brake cylinder. A change-over device may be configured to switch the relay valve between the different positions, wherein the change-over device may be in line between the auxiliary reservoir and the relay valve. A railway vehicle may be in fluid communication with the distributor valve system via the brake pipe.

### CROSS REFERENCE TO RELATED APPLICATION

This application claims priority to U.S. Provisional Patent Application No. 61/897,579, filed Oct. 30, 2013, the disclosure of which is hereby incorporated by reference in its entirety.

### BACKGROUND OF THE INVENTION

1. Field of the Invention

This disclosure relates generally to a braking system for a railway vehicle and, more particularly, to a three stage distributor valve of a braking system for a railway vehicle.

2. Description of Related Art

Conventional distributor valve systems have a dual-mode arrangement with a first brake pressure target for an unloaded railway car and a second brake pressure target for a loaded railway car. Improvements in railway cars have recently led to the development of lighter weight wagons that can accept heavier payloads. Conventional distributor valve systems, however, are not optimized for use with lightweight wagons because they provide a much greater brake pressure than is necessary to provide full braking service. Because a higher braking pressure is applied to the wheels of an unloaded lightweight wagon, the wheels can often lock due to the application of full service braking application. In this locked position, the wheels do not rotate, but rather slide along the rails they rest on. This sliding motion can create flat spots on the wheels of the wagon, thereby creating an imperfect circle. These flat spots can cause the wheels to rotate unevenly and off-balance, causing bumpy and dangerous conditions for the railway vehicle.

### SUMMARY OF THE INVENTION

While various distributor valve systems are known in the railway industry, improved distributor valve systems that include several different brake pressure targets for different wagon weights are desired. Additionally, improved distributor valve systems that provide manual control of the selected brake pressure target are also desired in the railway field. Moreover, the railway industry continues to demand improved distributor valve systems having improved structures and economies of manufacture.

In view of the disadvantages associated with the prior art distributor valve systems, it is desirable to provide an improved distributor valve system that, upon manual selection of a brake pressure target, provides a pre-determined amount of brake pressure to a railway vehicle. Various aspects of a distributor valve system and a method for braking a railway vehicle using a distributor valve system are described in detail herein. In one aspect, a distributor valve system for a railway vehicle may include a brake pipe, a relay valve, an auxiliary reservoir in line between the brake pipe and the relay valve to establish fluid communication between the brake pipe and the relay valve, and a brake cylinder in fluid communication with the relay valve. The relay valve may have a plurality of positions corresponding to different amounts of pressurized air applied to the brake cylinder. The relay valve may include a plurality of chambers that are filled with pressurized air according to the weight of a railway vehicle. The relay valve may have three chambers. The distributor valve system may further include a change-over device configured to switch the relay valve between the different positions, wherein the change-over device may be in line between the auxiliary reservoir and the relay valve. The distributor valve system may further include a railway vehicle in fluid communication with the distributor valve system. The distributor valve system may further include a main control valve in fluid communication with the auxiliary reservoir and the relay valve, and a maximum pressure limiter positioned above the main control valve. The distributor valve system may further include an automatic release valve in fluid communication with the brake pipe and a control reservoir, wherein the brake pipe and the control reservoir are in fluid communication. The distributor valve may further include an equalizing valve configured to equalize the auxiliary reservoir air pressure with the control reservoir air pressure, wherein the equalizing valve is in line between the brake pipe and the control reservoir.

According to yet another aspect, a method of braking a railway vehicle using a distributor valve system may include the steps of: (a) providing a distributor valve system on a railway vehicle, as described hereinabove, (b) providing pressurized air from the brake pipe into the auxiliary reservoir, (c) providing pressurized air from the auxiliary reservoir to the relay valve, and (d) selecting a position for the relay valve, wherein the relay valve is configured to include a plurality of different positions corresponding to different amounts of pressurized air that is provided to the brake cylinder. A further step of the method may include providing pressurized air from the relay valve to the brake cylinder. The relay valve may include three chambers corresponding to the three different positions of the relay valve. The method may further include the step of providing a change-over device configured to switch the relay valve between the different positions, wherein the change-over device is in line between the auxiliary reservoir and the relay valve. At a first position, the change-over device may direct pressurized air into three chambers of the relay valve. At a second position, the change-over device may direct pressurized air into two chambers of the relay valve. At a third position, the change-over device may direct pressurized air into one chamber of the relay valve. The method may further include the step of limiting the maximum pressure of the distributor valve system by using a maximum pressure limiter, which may be positioned above a main control valve in line between the auxiliary reservoir and the relay valve. The method may further include the step of providing an automatic release valve in fluid communication with the brake pipe and a control reservoir, wherein the brake pipe and the control reservoir may be in fluid communication. The method may further include the step of providing an equalizing valve that provides equalization of the auxiliary reservoir air pressure with the control reservoir air pressure, wherein the equalizing valve may be in line between the brake pipe and the control reservoir.

These and other features and characteristics of the distributor valve system, as well as the method of braking a railway vehicle using the distributor valve system, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic drawing of a distributor valve system for a railway vehicle in accordance with this disclosure, depicting the pressurized air path from a brake pipe of the railway vehicle to an auxiliary reservoir and a control reservoir.

FIG. 2 is a schematic drawing of the distributor valve system shown in FIG. 1, depicting the pressurized air path during a brake application to the railway vehicle in a first position.

FIG. 3 is a schematic drawing of the distributor valve system shown in FIG. 1, depicting the pressurized air path during a brake application to the railway vehicle in a second position.

FIG. 4 is a schematic drawing of the distributor valve system shown in FIG. 1, depicting the pressurized air path during a brake application to the railway vehicle in a third position.

### DESCRIPTION OF THE DISCLOSURE

For purposes of the description hereinafter, spatial orientation terms, as used, shall relate to the referenced aspect as it is oriented in the accompanying drawings, figures, or otherwise described in the following detailed description. However, it is to be understood that the aspects described hereinafter may assume many alternative variations and configurations. It is also to be understood that the specific components, devices, and features illustrated in the accompanying drawings, figures, and described herein are simply exemplary and should not be considered as limiting.

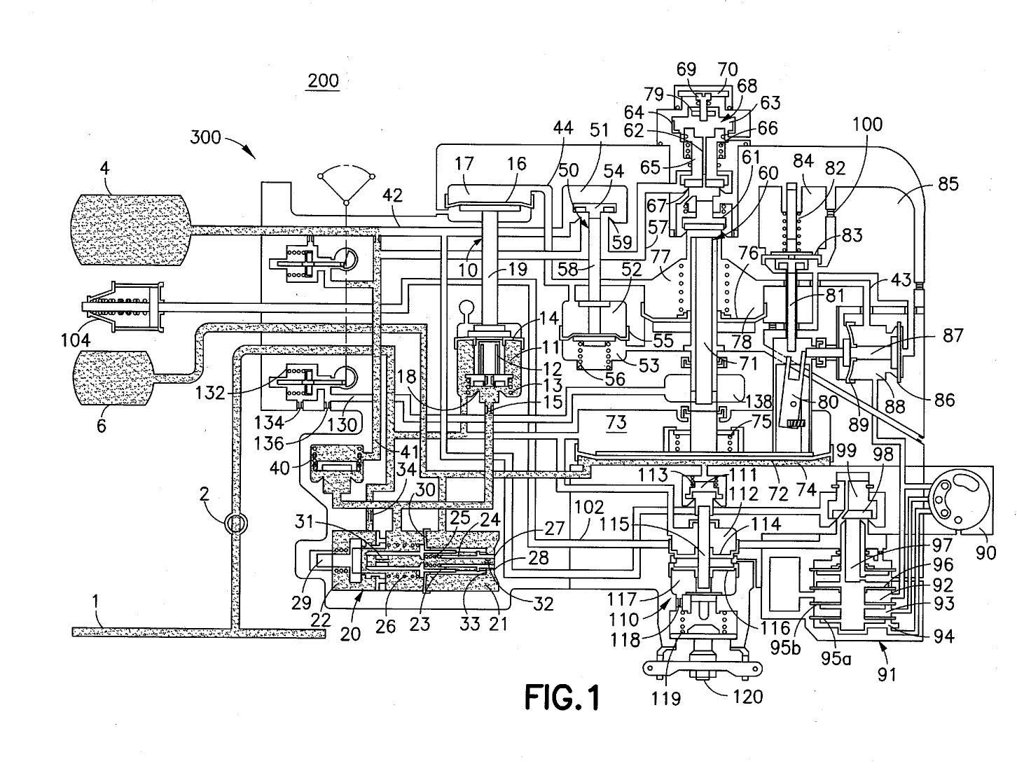

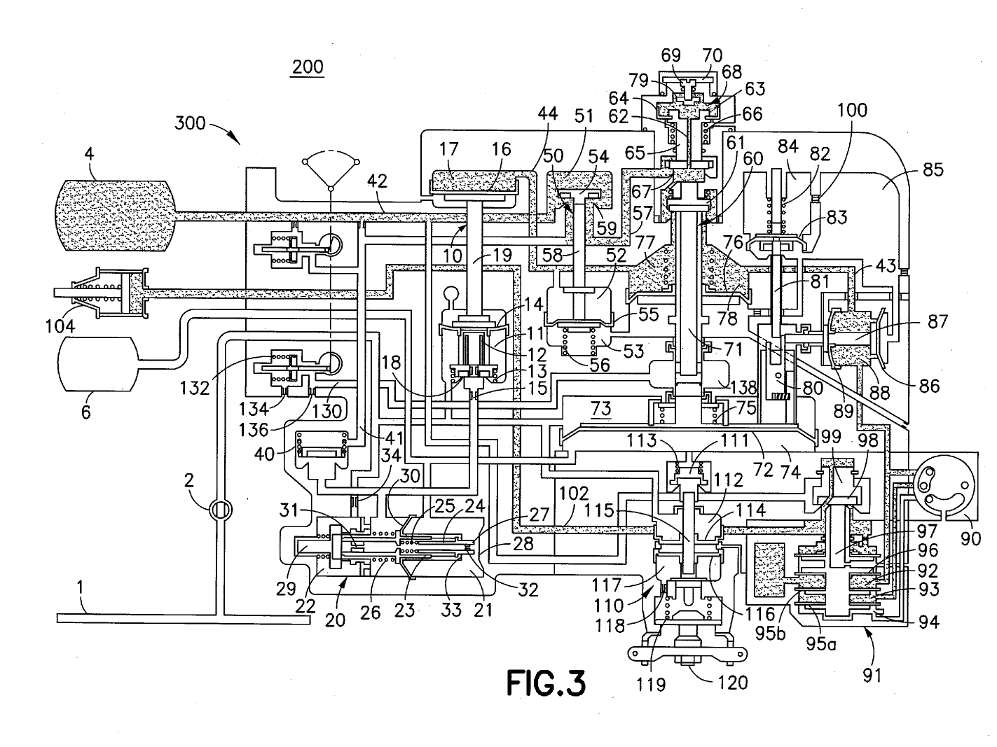

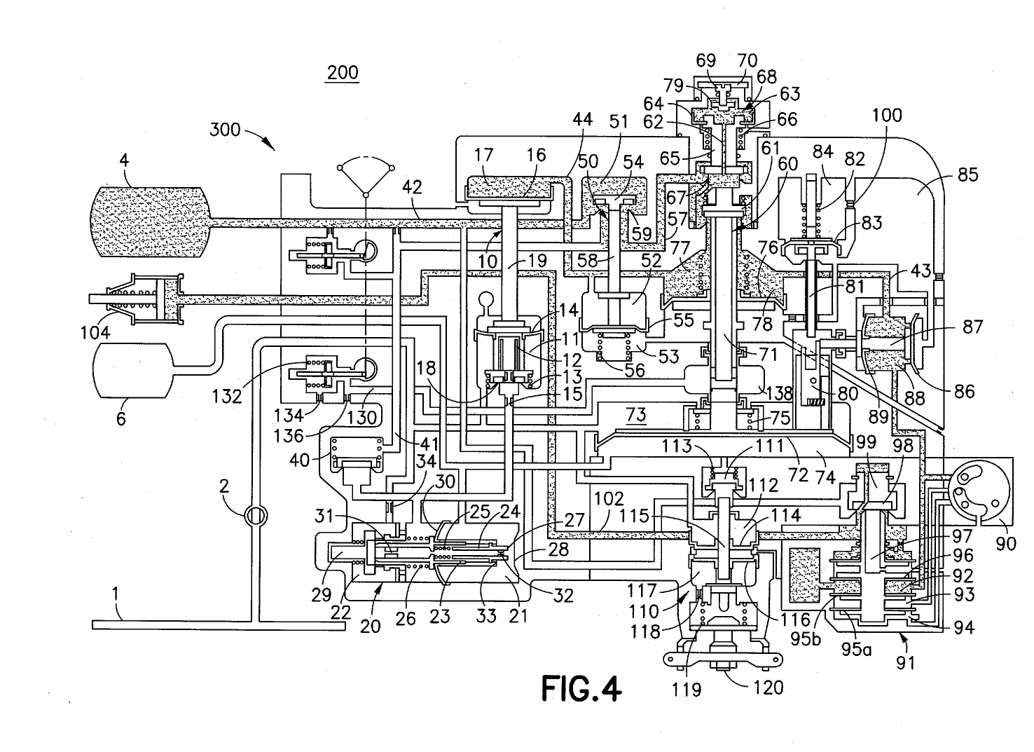

Referring to FIGS. 1-4, a distributor valve system for a railway vehicle, such as a railway wagon, is described herein. The operation of the distributor valve system will be described in greater detail following the description of the system. A railway vehicle 200 is in fluid communication with a distributor valve system 300 via a brake pipe 1. The brake pipe 1 is fluidly connected to an on-off cock 2. The brake pipe 1 can be isolated from the railway vehicle 200 by closing the on-off cock 2. In one aspect, the on-off cock 2 may be included in a bracket on the distributor valve system 300. This bracket (not shown) may also include connections to an auxiliary reservoir 4, a control reservoir 6, and/or a brake cylinder 104. The brake pipe 1 of the railway vehicle 200 is fluidly connected to an auxiliary reservoir 4 via a sealing valve 10 and a check valve 40. The auxiliary reservoir 4 is in fluid communication with the check valve 40 via the channel 41. The sealing valve 10 includes two chambers 11, 17, a rod 12, a spring 13, a valve stem 19, and two diaphragms 14, 16. The diaphragm 14 is positioned on an end of the rod 12. The diaphragm 16 is positioned on an end of the valve stem 19. Pressurized air from the chamber 17 presses down on the diaphragm 16. The spring 13 is positioned between the bottom end of the rod 12 and a seat 18. A choke 15 is positioned in-line between the sealing valve 10 and the check valve 40. The choke 15 is used to regulate the flow rate of pressurized air that exits from the sealing valve 10, thereby regulating the filling time of the auxiliary reservoir 4. The choke 15 may be opened or closed according to the desired flow rate of pressurized air exiting from the sealing valve 10.

The brake pipe 1 is also fluidly connected to a control reservoir 6 via the sealing valve 10 and an equalizing/filling valve 20. The equalizing/filling valve 20 includes a first chamber 21 and a second chamber 22, which are separated by a diaphragm 30. Each chamber 21, 22 includes a valve 23, 29. A valve stem 24 is also positioned in the chamber 21. A first spring 25 is disposed within the valve 23 and valve stem 24. The spring 25 presses a sliding choke valve 27 against a stop 28. A second spring 26 is positioned between the diaphragm 30 and the valve 29. A sensitivity choke 31 is disposed in the chamber 22. Another choke 32 is positioned on an end of the valve stem 24.

The auxiliary reservoir 4 is also in fluid communication with an initial admission valve 50 via the channel 42. The initial admission valve 50 is positioned in line between the auxiliary reservoir 4 and a main control valve 60. The initial admission valve 50 includes a stem 58 with an inlet valve 54 attached to an upper end of the stem 58. The inlet valve 54 moves up and down in a chamber 51. When the inlet valve 54 is pressed down from a top surface, the inlet valve 54 rests on a seat 59. A bottom portion of the stem 58 rests on a spring 56. A diaphragm 55 is positioned around the bottom portion of the stem 58 and separates two chambers 52, 53.

The initial admission valve 50 and the main control valve 60 are in fluid communication via the channel 57. The main control valve 60 includes an inlet valve 61 and a valve 65, which has an inner channel 62 for providing pressurized air from the auxiliary reservoir 4 to a chamber 63 above a diaphragm 64. A spring 66 is disposed between upper and lower edges of the valve 65 so when the force of the spring 66 is overcome, the valve 65 rests against a main control valve seat 67. A maximum pressure limiter 68 is positioned above the main control valve 60 and includes a pestle 69 and cover 70. Upon opening the cover 70, the pestle 69 can be rotated, causing the pestle 69 to move upward or downward depending on the direction of rotation. By rotating the pestle 69, a pressure plate 79 may be moved up or down, either increasing or decreasing the volume of pressurized air in the chamber 63.

The main control valve 60 also includes a hollow valve stem 71 that includes a diaphragm 72 attached to an end opposite of the inlet valve 61. The diaphragm 72 separates two chambers 73, 74. A spring 75 is disposed on a lower end of the hollow valve stem 71 above the diaphragm 72. An additional diaphragm 76 is disposed in a chamber 77, which is positioned at an intermediate position on the hollow valve stem 71. A spring 78 presses down on the diaphragm 76.

A rocker lever 80 is positioned in the chamber 73 of the main control valve 60. The rocker lever 80 is configured to come in contact with an accelerator valve stem 81. An intermediate portion of the accelerator valve stem 81 has a diaphragm 83 attached thereto with a spring 82 positioned on an upper surface of the diaphragm 83. The diaphragm 83 separates a chamber 84 from a chamber 85. An additional diaphragm 86 separates the chamber 85 and an additional chamber 88. Pressurized air from the chamber 85 moves the diaphragm 86 and a locking member 87 further to the left. The locking member 87 is disposed in the chamber 88 positioned between the two diaphragms 86 and 89. Pressure on the right side of the diaphragm 89 eventually pushes the locking member 87 against the rocker lever 80.

The chamber 88 is in fluid communication with a change-over device 90 and a relay valve 91. The chamber 88 is in line between the main control valve 60 and the relay valve 91. In one aspect, the change-over device 90 may be manually actuated to switch between different positions. However, additional types of change-over devices are contemplated such as an automatic change-over device or an electronic change-over device. The relay valve 91 includes a plurality of chambers. In one aspect, the relay valve 91 may include three chambers 92, 93, 94. A lower chamber 94 is separated from a middle chamber 93 by a small diaphragm 95a. The middle chamber 93 and an upper chamber 92 are separated by another small diaphragm 95b. A large diaphragm 96 rests on the top surface of the upper chamber 92. A hollow extension stem 97 extends vertically in the relay valve 91. The hollow extension stem 97 may include an inlet valve 98 on an upper end of the hollow extension stem 97. The diaphragms 95, 96 of the relay valve 91 are positioned around the hollow extension stem 97. Upon pressurized air pushing the diaphragms 95, 96 upward, the inlet valve 98 is lifted by the hollow extension stem 97 into a bore 99 of the relay valve 91. The relay valve 91 may also be in fluid communication with a brake cylinder 104 of the railway vehicle 200 via a channel 102.

The distributor valve system 300 may also include an automatic release valve 110 positioned next to the relay valve 91. The automatic release valve 110 is in fluid communication with the brake pipe 1 and the control reservoir 6 via the chamber 74 in the main control valve 60. The automatic release valve 110 is configured to enable the brake on an individual railway vehicle to be released manually. When the system is fully charged, the chamber 74 is isolated from the atmosphere by a valve 111. A chamber 117 is vented to atmosphere via a choke 118, while a chamber 112 is under pressure from the brake pipe 1. Two diaphragms 114, 116 separates the two chambers 112, 117. The two diaphragms 114, 116 are positioned around a hollow valve stem 115. A spring 119 holds a lever 120 in place on a lower portion of the automatic release valve 110. The hollow valve stem 115 extends vertically through the automatic release valve 110 and is attached to the lever 120 at a lower portion of the hollow valve stem 115. A spring 113 also presses down on an upper surface of the valve 111.

In view of the description of the distributor valve system 300 hereinabove and FIGS. 1-4, a method of operation of the system is described below. In reference to FIG. 1, the operation of the distributor valve system 300 allows for different amounts of pressurized air to be supplied to the brake cylinder 104 depending on the type and weight of the railway vehicle 200. To effectively supply this pressurized air, the auxiliary reservoir 4 and the control reservoir 6 must be sufficiently filled. Pressurized air flows from the brake pipe 1 to the auxiliary reservoir 4 via the chamber 11 of the sealing valve 10 and the check valve 40. The flow rate and filling time of the auxiliary reservoir 4 may be regulated by the choke 15. At the same time that the auxiliary reservoir 4 is filled, the brake pipe 1 directs pressurized air to the control reservoir 6 via the opened sealing valve 10 and the sensitivity choke 31 of the equalizing/filling valve 20.

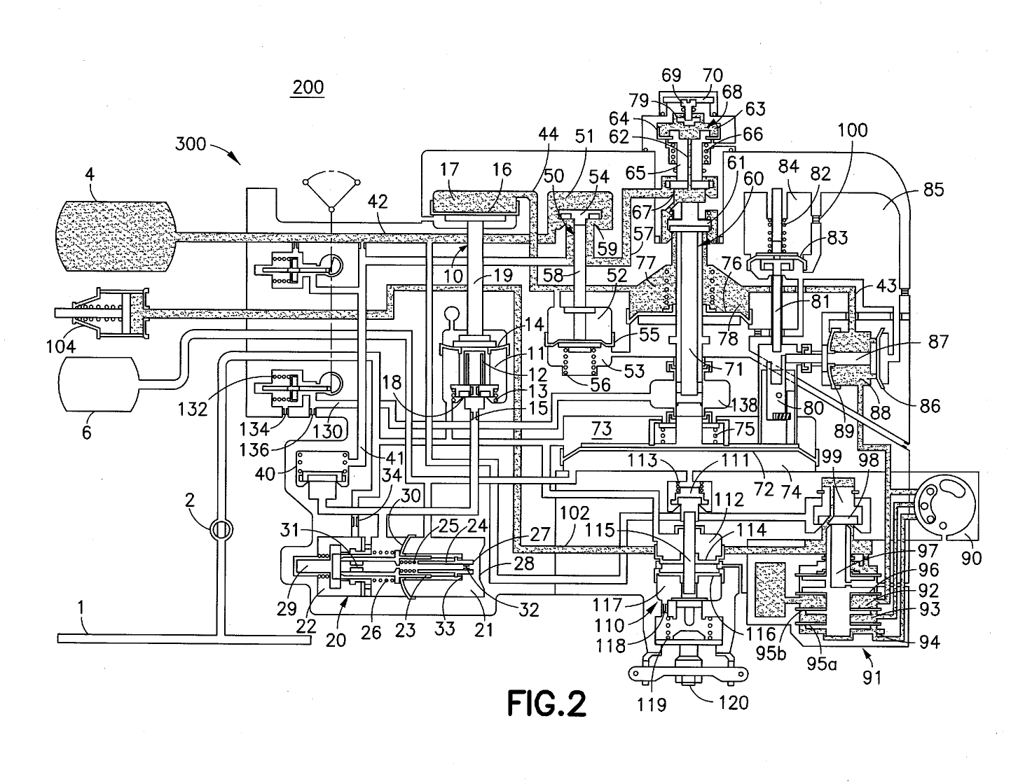

In reference to FIGS. 2-4, after the reservoirs 4, 6 have been sufficiently filled, the brakes can be applied to the railway vehicle 200. Pressurized air from the auxiliary reservoir 4 is directed into the chamber 51 above the inlet valve 54 of the initial admission valve 50 via the channel 42. Simultaneously, pressurized air is directed, via the inner channel 62, into the chamber 63 above the diaphragm 64 of the maximum pressure limiter 68. As the pressure builds in the chamber 63, the valve 65 begins to move downward. In one aspect, when the pressure builds to a value between 3.7 bar and 3.9 bar, the biasing force of the spring 66 is overcome and the valve 65 may rest on the seat 67. It is contemplated that different ranges of pressure can be used to overcome the biasing force of the spring 66 depending on the resiliency of the spring used therein. When the valve 65 rests on the seat 67, pressurized air can no longer enter the chamber 63 of the maximum pressure limiter 68 via the inner channel 62. In this way, the chamber 63 above the inlet valve 61 has a constantly regulated pressurization of air. This regulation is done independent of the pressure range that is supplied in the auxiliary reservoir 4. In this way, the sensitivity of the distributor valve system 300 can be increased at a gradual pace according to the permitted pressure range of the maximum pressure limiter 68. Additional details of the operation of the maximum pressure limiter 68 are described herein below.

As the brake of the railway vehicle 200 is being applied, the distributor valve system 300 experiences a decrease in brake pipe pressure. The decrease in brake pipe pressure acting on the diaphragm 72 in the chamber 73 results in the main control valve 60 moving upwards. The pressurized air from the control reservoir 6 in the chamber 74 pushes upwards on the diaphragm 72, thereby assisting in the upward movement of the main control valve 60. The upward movement of the main control valve 60 immediately brings the rocker lever 80 into contact with the end of the accelerator valve stem 81. This causes the accelerator valve stem 81 to lift off a seating, thus allowing a rapid escape of brake pipe air to flow from the chamber 73 to the chamber 85. The flow of brake pipe air striking an under surface of the accelerator valve stem 81 holds the accelerator valve stem 81 open while the pressure in the chamber 85 presses against the diaphragm 86. This pressure against the diaphragm 86 causes the locking member 87 to push the rocker lever 80 to the left, thereby disengaging the accelerator valve stem 81 from the rocker lever 80. Additionally, the brake pipe air that is directed into the chamber 85 also flows through the choke 100 into another chamber 84. Once the pressures in the chambers 84, 85 are approximately equal, the accelerator valve stem 81 can close under the influence of the spring 82.

The disengagement of the rocker lever 80 from the accelerator valve stem 81 is initially due to the brake pipe air pressure in the chamber 85 acting on the diaphragm 86. However, this is quickly superseded by the brake cylinder air pressure in the chamber 88 acting on the diaphragm 89. Thus, during all further regulation of the brake in application or release operation, the accelerator valve stem 81 is held inoperative. After the accelerator valve stem 81 has closed, the brake pipe air pressure in the chambers 84, 85 are vented to atmosphere by chokes. By modifying the bore of the choke 100, the length of time for when the accelerator valve stem 81 is open can be varied and, consequently, the volume of brake pipe air vented from the distributor valve system 300 can also be varied.

During the application of the railway vehicle's brake, the rapid drop in brake pipe air pressure in the chamber 73 of the main control valve 60 also opens the inlet valve 61 by means of the hollow valve stem 71. The control reservoir air pressure in the chamber 74 presses upward on the diaphragm 72, thereby lifting the hollow valve stem 71. Upon the opening of the inlet valve 61, pressurized air from the auxiliary reservoir 4 flows through the channel 42, the inlet valve 54 of the initial admission valve 50, the channel 57, and through the inlet valve 61. This pressurized air is then directed through the channel 43, the chamber 88 of the locking member 87, and into the relay valve 91. Filling of the brake cylinder 104 with pressurized air is then achieved by directing the pressurized air from the relay valve 91 to the brake cylinder 104 via the channel 102.

The amount of pressurized air directed into the relay valve 91 is regulated by the change-over device 90. In one aspect, the change-over device 90 is configured to operate at three different positions. An operator of the railway vehicle can manually switch the change-over device 90 between these three positions. Depending on which position is selected, a number of the chambers 92, 93, 94 can be closed off so as not to allow pressurized air to enter therein. In a first position, corresponding to a normal railway vehicle with a load, the relay valve 91 provides a high volume of pressurized air to the brake cylinder 104. In this first position, the pressurized air from the auxiliary reservoir 4 is directed into three chambers 92, 93, 94 of the relay valve 91. None of the chambers 92, 93, 94 are closed off in this position. In this position, there is no pressure acting upon the small diaphragm 95, but instead the pressure acts upon the large diaphragm 96. The upward pressure on the large diaphragm 96 lifts the inlet valve 98 of the bore 99, thereby permitting the pressurized air to flow from the relay valve 91 to the brake cylinder 104 via the channel 102.

In a second position, corresponding to a light weight railway vehicle with a load, the relay valve 91 provides a moderate volume of pressurized air to the brake cylinder 104. One chamber 94 is closed off via the change-over device 90, while two chambers 92, 93 are kept open. The pressurized air from the auxiliary reservoir 4 is directed into both of these chambers 92, 93. The pressurized air acts upon the diaphragms 95, 96, thereby lifting the inlet valve 98. The pressurized air then flows from the relay valve 91 to the brake cylinder 104 via the channel 102.

In a third position, corresponding to a railway vehicle with no load, the relay valve 91 provides a small volume of pressurized air to the brake cylinder 104. Two chambers 93, 94 are closed and one chamber 92 is left open. The pressurized air from the auxiliary reservoir 4 is directed into this chamber 92. The pressurized air acts upon the diaphragms 95, 96, thereby lifting the inlet valve 98. The pressurized air then flows from the relay valve 91 to the brake cylinder 104 via the channel 102.

Upon the brake cylinder 104 reaching a predetermined pressure, the pressure acting on the diaphragm 55 causes the inlet valve 54 of the initial admission valve 50 to close. In one aspect, the predetermined pressure to act on the diaphragm 55 of the brake cylinder 104 is 0.70 bar. In order to prevent the premature closing of the inlet valve 61 of the main control valve 60 and the initial admission valve 50 due to the rapid build up of pressure in the relatively small chambers within the distributor valve system 300, a supply of sustaining air from the chamber 85 is directed momentarily below the diaphragms 76 and 55. This pressurized air is eventually vented to atmosphere via a choke. Due to the above-mentioned operation, during the initial stage of a brake application an efficient “in-shot” of pressurized air is provided to the brake cylinder 104. This causes an almost instantaneous rise in pressure, thus causing the brake cylinder piston (not shown), acting through brake rigging (not shown), to move the brake shoes (not shown) rapidly into contact with the railway vehicle's wheels (not shown). After this “in shot” of pressurized air is admitted, the pressurized air can flow from the auxiliary reservoir 4 to the brake cylinder 104 via the relay valve 91.

In regards to the main control valve 60, before the hollow valve stem 71 can lift the inlet valve 61 of the main control valve 60 from its seating, the spring 75 must be compressed. Therefore, when the chamber 74 is at a higher pressure than the chamber 73, the pressurized air presses upward on the diaphragm 72 compressing the springs 75 and 78. This enhances the control of the low brake cylinder pressure and lifts the inlet valve 61 off its seating.

A reduction in the brake pipe pressure may be sufficient to cause the valve 23 of the equalizing/filling valve 20 to move to the left. In one aspect, a reduction in the brake pipe pressure by 0.08 bar is sufficient to cause this movement. This movement of the valve 23 to the left allows the spring 25 to close the valve 23 against a seat 33. This closing of the valve 23 restricts fluid communication between the brake pipe 2 and the control reservoir 6 to only the choke 32. If the brake pipe pressure is reduced even further, the valve 23 may move further to the left, thereby compressing the spring 26 against the valve 29. In one aspect, this further reduction in brake pipe pressure may be equal to 0.20 bar. As the spring 26 is compressed, the valve 29 is moved off its seating. Thus, the control reservoir 6 is positively isolated from the brake pipe 1, while simultaneously the auxiliary reservoir 4 is connected to the brake pipe 1 via the check valve 40 and the channel 41.

Pressurized air that flows from the auxiliary reservoir 4 to the brake cylinder 104, as described hereinabove, also flows via the channel 57, the chamber 77, and the channel 44 into the chamber 17 of the sealing valve 10. This pressurized air presses down on the diaphragm 16 against the brake pipe pressure acting upwards on the diaphragm 14 in the chamber 11. When the pressure in the chamber 17 reaches a predetermined amount, the sealing valve 10 closes against its seat 18, thereby preventing pressurized air from the brake pipe 1 to flow into the auxiliary reservoir 4 via the choke 15. In one aspect, this predetermined amount of pressure is equal to 0.50 bar.

After the distributor valve system 300 has provided the “in-shot” of pressurized air and the sealing valve 10 and initial admission valve 50 have been closed, the control reservoir 6 and the valve 29 of the equalizing/filling valve 20 are open. This position of the distributor valve system 300 allows pressurized air from the auxiliary reservoir 4 to flow to the brake cylinder 104 via the relay valve 91, wherein the bore 99 of the relay valve 91 can be adjusted to regulate the brake cylinder filling time.

As the air pressure in the chamber 77 of the main control valve 60 rises, a downward force is exerted on the hollow valve stem 71 via the diaphragm 76. This downward force, along with the force of the springs 75 and 78, acts against the upward force created by the pressure differential across the diaphragm 72. When the downward and upward forces acting on the hollow valve stem 71 are balanced, the hollow valve stem 71 moves downward into a “lap position”, thereby allowing the inlet valve 61 to close. Thus, when the main control valve 60 is in this “lap” position, there is neither the admitting nor releasing of air from the brake cylinder 104. Any further reduction in the brake pipe pressure causes the downward force to decrease, thereby unbalancing the forces on the hollow valve stem 71 and causing the hollow valve stem 71 to move upwards. This upward movement of the hollow valve stem 71 opens the inlet valve 61, allowing pressurized air from the auxiliary reservoir 4 to flow to the brake cylinder 104 until the increasing pressure in the chamber 77 restores the balance of forces on the hollow valve stem 71. As the main control valve 60 may be sensitive to small changes in the forces acting on the hollow valve stem 71, the brake cylinder pressure can be increased by very small increments, thus providing a precise control of the braking. This can continue until a maximum pressure is reached in the brake cylinder 104. In one aspect, this maximum pressure range may be, for example, 3.7-3.9 bar. In the event that pressurized air should leak from the brake cylinder 104, due to a faulty piston seal or pipe connection, the corresponding fall in air pressure in the chamber 77 will unbalance the forces on the hollow valve stem 71 causing the hollow valve stem 71 to rise and open the inlet valve 61. As the inlet valve 61 rises, pressurized air from the auxiliary reservoir 4 is admitted to the brake cylinder 104 to compensate for the leakage. Further, pressurized air from the brake pipe 1 can flow to the auxiliary reservoir 4 via the open valve 29 of the equalizing/filling valve 20 and check valve 40, thus maintaining the safe and effective application of the brake.

The maximum pressure in the distributor valve system 300 is regulated by the maximum pressure limiter 68. The resiliency of the spring 66 of the maximum pressure limiter 68, as well as the diameter of the pressure plate 79 screwed on the pestle 69, are chosen such that the inlet valve 61 is positioned on its seating only when the predetermined maximum pressure in the brake cylinder 104 is achieved. Brake cylinder pressure from the chamber 77 flows through the inner channel 62 into the chamber 63 above the diaphragm 64. Therefore, the resiliency of the spring 66 and the diameter of the pressure plate 79 screwed onto the pestle 69 can be chosen so as to provide a predetermined amount of resistance before the pressure acting upon the diaphragm 64 causes the diaphragm 64 to move downward, which causes the inlet valve 61 to close against its seat. The adjustment of the maximum brake cylinder pressure may also be done by rotating the pestle 69 after opening the cover 70, thereby compressing the spring 66 to a certain length.

The distributor valve system 300 also performs several operations during the release of the brake of the railway vehicle 200. As the pressure in the brake pipe 1 is increased, the increased pressure in the chamber 73 acting on the diaphragm 72 of the hollow valve stem 71 causes the hollow valve stem 71 to move downward from the “lap” position. The top portion of the hollow valve stem 71 can then disengage from the bottom surface of the inlet valve 61, thereby allowing pressurized air from the brake cylinder 104 to escape to atmosphere. The pressurized air flows from the brake cylinder 104 to the hollow valve stem 71 and a chamber 138. The pressurized air then flows to chokes 134, 136 of a change-over device 132 via the channel 130. The bore of each choke 134, 136 can be adjusted to change the vent time of the pressurized air to atmosphere. Thus, by raising the brake pipe pressure incrementally, the brake can be released by very small increments so as to provide the precise control of the braking during release.

If, during brake release of the railway vehicle 200, the air pressure in the brake pipe 1 should rise above the air pressure in the auxiliary reservoir 4, pressurized air from the brake pipe 1 will flow through the choke 34 past the valve 29 in the equalizing/filling valve 20, through the check valve 40 and into the auxiliary reservoir 4. The valve 29 is held open in this position due to the pressure differential between the auxiliary reservoir 4 and the control reservoir 6 acting on the diaphragm 30 of the equalizing/filling valve 20. By using this arrangement, the auxiliary reservoir 4 can be recharged during the release of the brake. As the auxiliary reservoir 4 is recharged, the air pressure will begin to equalize with the air pressure in the control reservoir 6. In this situation, the spring 26 presses the valve 23 to the right, thereby allowing the valve 29 to close.

Upon the brake cylinder pressure being reduced to a certain amount, the brake pipe pressure in the chamber 11 acting on the diaphragm 14 lifts the valve stem 19, thus opening the sealing valve 10. In one aspect, when the brake cylinder pressure has been reduced to approximately 0.50 bar, the sealing valve 10 is opened.

The sealing valve 10 may also open under the influence of the spring 13, provided that the pressure from the brake pipe 1 acting in the chamber 11 does not exceed the air pressure of the auxiliary reservoir 4 in the chamber 17 by about 0.60 bar. However, if the brake is released using a high pressure releasing surge resulting in the brake pipe pressure rising above the normal running pressure, the sealing valve 10 will remain closed by the pressure in the chamber 11, even though there is no pressure acting against the diaphragm 16. In one aspect, when the brake pipe pressure rises about 0.60 bar above the normal running pressure of about 5.0 bar, the sealing valve 10 will remain closed. Further recharging of the auxiliary reservoir 4 can continue after the sealing valve 10 opens under action of the spring 13. This arrangement of the sealing valve 10 and the equalizing/filling valve 20 ensures an effective protection of the auxiliary reservoir 4 and the control reservoir 6 against overcharge during brake release. This enables the high pressure releasing surge to be held for a longer amount of time than is required to effect a complete brake release.

When the brake cylinder pressure falls below a certain pressure, brake pipe pressure in the chamber 73 acting on the locking member 87 overcomes the brake cylinder pressure acting in the chamber 88 on the diaphragm 89, thereby freeing the rocker lever 80 to return to its normal position and reactivating the accelerator valve stem 81 in the event of re-braking. In one aspect, this operation occurs when the brake cylinder pressure falls below about 0.25 bar. Thus, the accelerator remains inoperative when regulating the brake with low brake cylinder pressures in excess of about 0.25 bar.

During the final stages of brake release and when the brake pipe pressure, in one aspect, has risen to approximately 4.80 bar, the valve 23 moves towards the right and separates from the valve 29, which closes. The spring 25 presses the sliding choke valve 27 against the stop 28 in the equalizing/filling valve 20. In this position, communication between the brake pipe 2 and the control reservoir 6 is restricted by the choke 32. When the pressure differential across the diaphragm 30 is small, the force of the spring 26 is greater than the force of the spring 25 so that the valve 23 moves further towards the right. The valve stem 24 opens and final equalization takes place via the sensitivity choke 31. Therefore, the equalization of the brake pipe and the control reservoir pressure is completely independent from the brake cylinder pressure so that pressure leakage from the brake cylinder does not influence a complete brake release. This arrangement also protects the control reservoir 6 from a loss in air pressure, even under unusual circumstances. When the control reservoir 6 is charged to a normal running pressure or, in the event of its being overcharged, equalization with the brake pipe pressure is achieved via the sensitivity choke 31 and the valve stem 24. When the valve stem 24 is closed, the valve stem 24 restricts the loss of air from the control reservoir 6 in the event of a small, slow decrease in the brake pipe pressure. This can occur with a train requiring only a very light and brief brake application. When the valve stem 24 is closed, it can also retard the equalization of the control reservoir pressure with the brake pipe pressure during the brake release.

Operation and use of the automatic release valve 110 is described hereinafter. The automatic release valve 110 is located in a lower portion of the distributor valve system 300 and is used to manually release a brake on an individual railway vehicle 200. When the brake system is charged, pressurized air from the control reservoir 6 flows into the chamber 74. This pressurized air is isolated from the atmosphere by the valve 111. Pressurized air in the chamber 117 is vented to atmosphere via the choke 118 when the chamber 112 is under pressure from the brake pipe air. This brake pipe air acts on the diaphragm 114 to press the hollow valve stem 115 downwards. The spring 119 holds the lever 120 of the automatic release valve 110.

The automatic release valve 110 operates in several different methods. In a first operation, the automatic release valve 110 is used to release air pressure when the control reservoir 6 becomes overcharged. In order to release excess pressure in the control reservoir 6, a single short manual operation of the lever 120 lifts the hollow valve stem 115, thereby opening the valve 111. This allows air from the chamber 74 and the control reservoir 6 to flow down the hollow valve stem 115 and into the chamber 117. The air is directed to atmosphere from the chamber 117 via the choke 118. This quick build up of air pressure in the chamber 117 acts on the bottom surface of the diaphragm 116, which has a larger effective area than the diaphragm 114, which is subject to brake pipe pressure in the chamber 112. Thus, the pressure in the chamber 117 holds the valve 111 open until it has fallen to a value below that of the pressure in the chamber 112. At this point in time, the hollow stem valve 115 moves down and the spring 113 closes the valve 111. Using this operation, the control reservoir overcharge is released automatically and with minimal loss of pressurized air in the shortest amount of time.

In a second operation, the automatic release valve 110 is used for a complete brake pressure release. With the brake pipe 1 at about or exactly at 0.00 bar pressure and the brake fully applied, one short quick manual operation of the lever 120 is performed. With the brake pipe 1 being at atmospheric pressure and not providing pressure against the diaphragm 114, the valve 111 is held open due to the upward pressure on the diaphragm 116, until the chamber 117 is at atmospheric pressure as well. Because the brake pipe 1 is not providing pressure to the chamber 112, the pressure from the chamber 74 and the control reservoir 6 is directed into the chamber 117 and vented to atmosphere via the choke 118. By performing this function, the pressure from the control reservoir 6 is completely released to atmosphere until it is also at atmospheric pressure. The brake, therefore, is fully released as a consequence.

In a third operation, the automatic release valve 110 is operated by vacuum. This feature enables the automatic release valve 110 on the railway vehicle 200 to be operated remotely, quite often from a locomotive. This locomotive (not shown) must be suitably equipped with an apparatus (not shown) for enabling a vacuum to be created in the brake pipe. When the vacuum is created in the chamber 112 of the automatic release valve 110, atmospheric pressure acting on the underside of the diaphragm 116 causes the hollow valve stem 115 to lift, thereby opening the valve 111. Thereinafter, the automatic release valve 110 operates similarly to the above mentioned operations for an overcharged control reservoir 6 or a complete brake release.

While aspects of a distributor valve system 300 and methods of operation thereof were provided in the foregoing description, those skilled in the art may make modifications and alterations to these aspects without departing from the scope and spirit of the invention. Accordingly, the foregoing description is intended to be illustrative rather than restrictive. The invention described hereinabove is defined by the appended claims and all changes to the invention that fall within the meaning and the range of equivalency of the claims are to be embraced within their scope.

The invention claimed is:

1. A distributor valve system for a railway vehicle, comprising:
a brake pipe;
a relay valve;
an auxiliary reservoir in line between the brake pipe and the relay valve to establish fluid communication between the brake pipe and the relay valve; and
a brake cylinder in fluid communication with the relay valve,
wherein the relay valve has a plurality of positions corresponding to different amounts of pressurized air applied to the brake cylinder.

2. The distributor valve system as claimed in claim 1, wherein the relay valve includes a plurality of chambers that are filled with pressurized air according to the weight of a railway vehicle.

3. The distributor valve system as claimed in claim 2, wherein the relay valve has three chambers.

4. The distributor valve system as claimed in claim 2, further comprising a change-over device configured to switch the relay valve between the different positions, wherein the change-over device is in line between the auxiliary reservoir and the relay valve.

5. The distributor valve system as claimed in claim 4, further comprising a railway vehicle in fluid communication with the distributor valve system via the brake pipe.

6. The distributor valve system as claimed in claim 5, further comprising:
a main control valve in line between the auxiliary reservoir and the relay valve; and
a maximum pressure limiter positioned above the main control valve.

7. The distributor valve system as claimed in claim 6, further comprising an automatic release valve in fluid communication with the brake pipe and a control reservoir, wherein the automatic release valve is in line between the brake pipe and the control reservoir.

8. The distributor valve system as claimed in claim 7, further comprising an equalizing valve configured to equalize the auxiliary reservoir air pressure with the control reservoir air pressure, wherein the equalizing valve is in fluid communication with the brake pipe, the control reservoir, and the auxiliary reservoir.

9. A method of braking a railway vehicle using a distributor valve system, comprising the steps of:
a. providing a distributor valve system on a railway vehicle, the distributor valve system comprising:
a brake pipe;
a relay valve;
an auxiliary reservoir in line between the brake pipe and the relay valve to establish fluid communication between the brake pipe and the relay valve; and
a brake cylinder in fluid communication with the relay valve,
wherein, the relay valve has a plurality of positions corresponding to different amounts of air pressure applied to the brake cylinder, and
the railway vehicle is in fluid communication with the distributor valve system via the brake pipe;
b. directing pressurized air from the brake pipe into the auxiliary reservoir;
c. directing pressurized air from the auxiliary reservoir to the relay valve; and
d. selecting a position for the relay valve, wherein the relay valve is configured to include a plurality of different positions corresponding to different amounts of pressurized air that are provided to the brake cylinder.

10. The method of braking a railway vehicle as claimed in claim 9, further comprising the step of directing the selected amount of pressurized air from the relay valve to the brake cylinder.

11. The method of braking a railway vehicle as claimed in claim 9, wherein the relay valve includes three chambers corresponding to the three different positions of the relay valve.

12. The method of braking a railway vehicle as claimed in claim 9, further comprising the step of providing a change-over device configured to switch the relay valve between the different positions, wherein the change-over device is in line between the auxiliary reservoir and the relay valve.

13. The method of braking a railway vehicle as claimed in claim 12, wherein, at a first position, the change-over device directs pressurized air into three chambers of the relay valve; at a second position, the change-over device directs pressurized air into two chambers of the relay valve; and, at a third position, the change-over device directs pressurized air into one chamber of the relay valve.

14. The method of braking a railway vehicle as claimed in claim 9, further comprising the step of limiting the maximum pressure of the distributor valve system by using a maximum pressure limiter, which is positioned above a main control valve in line between the auxiliary reservoir and the relay valve.

15. The method of braking a railway vehicle as claimed in claim 9, further comprising the step of providing an automatic release valve in fluid communication with the brake pipe and a control reservoir, wherein the automatic release valve is in line between the brake pipe and the control reservoir.

16. The method of braking a railway vehicle as claimed in claim 9, further comprising the step of providing an equalizing valve that provides equalization of the auxiliary reservoir air pressure with the control reservoir air pressure, wherein the equalizing valve is in fluid communication with the brake pipe, the control reservoir, and the auxiliary reservoir.
